(19) United States
(12) Patent Application Publication
(10) Pub. No.: US 2010/0214293 A1
(43) Pub. Date: Aug. 26, 2010

(54) SYSTEM AND METHOD FOR USER INTERATION IN DATA-DRIVEN MESH GENERATION FOR PARAMETER RECONSTRUCTION FROM IMAGING DATA

(75) Inventors: Bart Jacob Bakker, Eindhoven (NL); Manoj Narayanan, Snohomish, WA (US); Axel Weber, Gilching (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,533

(22) PCT Filed: Nov. 15, 2006
(86) PCT No.: PCT/IB2006/054267

§ 371 Date: May 30, 2008

Related U.S. Application Data
(60) Provisional application No. 60/741,739, filed on Dec. 2, 2005.

(51) Int. Cl. G06T 17/20

(52) U.S. Cl. 345/423

(57) ABSTRACT

A system and method for iterative reconstruction with user interaction in data-driven, adaptive mesh generation for reconstruction of model parameters from imaging data is disclosed. The method includes reading input (110, 115) from a user and checking reconstructed parameters (130) for convergence after each iteration. A required computation time is estimated (130) after each iteration based on a current mesh grid and expected number of iterations and the mesh grid is updated (140). An on-line representation of the reconstructed parameters and an adapted mesh grid is displayed during the reconstruction (170) and a next iteration of the reconstruction is based on the adapted mesh grid (145).

The present disclosure relates generally to a system and method for user interaction in a direct, iterative reconstruction from image data using an adaptive mesh grid.

The data gathered from (molecular) imaging modalities such as positron emission tomography (PET) and single photon emission computed tomography (SPECT) scanners can be used to reconstruct model parameters, describing the concentration of tracer chemicals (e.g., the dynamic behavior of the concentration) in the body. Such parameters are described on a ‘voxel-by-voxel’ basis, where a voxel is a small volume element inside a three dimensional (3-D) grid that is super-imposed on the studied object. The size of the voxels inside this grid determines the spatial accuracy or resolution with which the distribution of the model parameters can be estimated. Several reconstruction methods (e.g., direct reconstruction from the list mode data and maximum a posteriori estimation) allow irregular voxel grids, e.g., grids that contain voxels of various shapes and sizes. The optimal choice for the layout of such a voxel grid is still an open issue.

State-of-the-art for reconstruction of image data includes reconstruction on “irregular” voxel grids with local variations in resolution (e.g., voxel size) and includes a static grid with higher resolutions in regions of interest, as indicated manually before reconstruction, for example, on a preliminary reconstruction, or a reconstruction based on another modality (e.g., CT-scan). State-of-the-art also includes content-adaptive mesh generation for image reconstruction, where resolution is increased automatically in regions of high spatial variation.

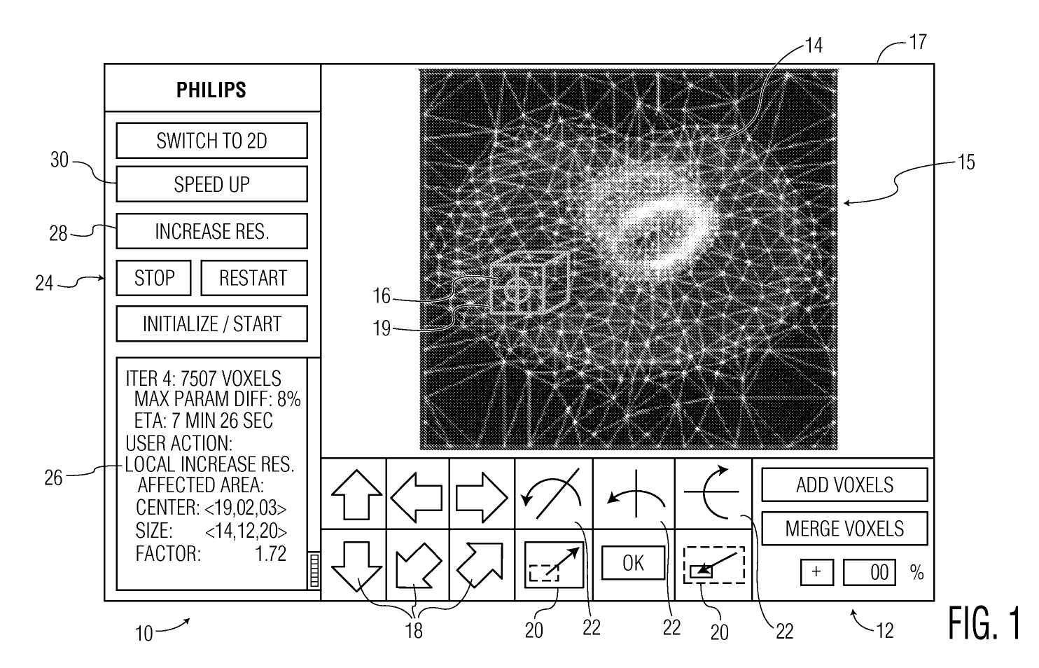

Mesh modeling of an image involves partitioning the image domain into a collection of nonoverlapping (generally polygonal) patches, called mesh elements, (here triangles are used as illustrated in FIG. 1); the image function is then determined over each element through interpolation from the mesh nodes of the elements. The contribution of a node to the image is limited to the extent of those elements attached to that node. With a mesh model, one can strategically place the mesh nodes most densely in regions containing significant features, resulting in a more compact representation of the image than a voxel representation.

High resolution, which is implemented through a very fine voxel grid, requires overly long computation times. Lower resolution, which is implemented with a coarser voxel grid, leads to a loss of spatial information and less accurate system output (e.g., parameter maps). Further, an optimal compromise between speed and high resolution is influenced by aspects including, for example, regions of interest, spatial variation, availability of sufficient statistics and availability or requirement of computation time. The regions of interest under consideration influence the requirements for higher resolution. Certain areas of the studied object may be of more importance than other areas, and subsequently require higher resolution. Also, higher resolution in the regions of “lesser” interest (e.g., background) yields no additional information of value, but still slows down the reconstruction process. Regarding spatial variation, model parameters may feature strong spatial variation from voxel-to-voxel in one area, yet vary more slowly in other areas. In areas where the variation of model parameters is relatively slow, only limited resolution is required, whereas areas of strong model parameter variation are best modeled through a finely meshed grid.

The estimation of model parameters for each voxel relies on a sufficient number of events (e.g., detector measurements) that are related to this particular voxel. If there are too few events due to too small a voxel size, for example, a poor signal-to-noise ratio (SNR) is implied, subsequently resulting in poor estimation. Thus, it can be seen that the availability of sufficient statistics influences an optimal compromise between speed and high resolution.

Of course, when unlimited time is available, a small voxel size throughout the entire grid would always be preferable, provided there is a sufficient number of detected events at the smaller voxel size. However, physicians have limited time available, and prefer not to wait for results. The relative importance of speed and accuracy therefore has a direct influence on the choice of resolution.

Therefore, it would be desirable to provide control over the reconstruction process to minimize computation time to prevent unnecessary waiting and ensure maximum resolution of the regions of interest within the boundaries of clinically acceptable reconstruction times.

The present disclosure relates to a method for iterative reconstruction with user interaction in data-driven, adaptive mesh generation for reconstruction of model parameters from imaging data. In an exemplary embodiment, the method includes reading input (both a priori (110) and on-line (115)) from a user and checking reconstructed parameters (130) for convergence after each iteration. A required computation time is estimated (130) after each iteration based on a current mesh grid and expected number of iterations and the mesh grid is subsequently updated (140). An on-line representation of the reconstructed parameters and an adapted mesh grid is displayed during the reconstruction (170) and a next iteration of the reconstruction is based on the adapted mesh grid (145).

In another exemplary embodiment, a system for iterative reconstruction with user interaction in data-driven, adaptive mesh generation for reconstruction of model parameters from imaging data is disclosed. The system includes a reconstructor configured to check reconstructed parameters for convergence after each iteration and estimate a required computation time after each iteration based on a current mesh grid and expected number of iterations. A user interface is configured to accept user input for the reconstructor to read and a display means 17 displays an on-line representation of the reconstructed parameters and an adapted mesh grid during the reconstruction updating the mesh grid 14, wherein a next iteration of the reconstruction is based on the adapted mesh grid.

In yet another exemplary embodiment, a computer software product for iterative reconstruction with user interaction in data-driven, adaptive mesh generation for reconstruction of model parameters from imaging data is disclosed. The product includes a computer-readable medium, in which program instructions are stored, which instructions, when read by a computer, cause the computer to read input (both a priori (110) and on-line (115)) from a user input device and check reconstructed parameters (130) for convergence after each iteration. The computer estimates a required computation time (130) after each iteration based on a current mesh grid and expected number of iterations and updates the mesh grid (140). The computer then directs an on-line representation of the reconstructed parameters and an adapted mesh grid to be displayed on a display means during the reconstruction (170) and bases a next iteration of the reconstruction on the adapted mesh grid (145).

Additional features, functions and advantages associated with the disclosed system and method will be apparent from the detailed description which follows, particularly when reviewed in conjunction with the figures appended hereto.

To assist those of ordinary skill in the art in making and using the disclosed system and method, reference is made to the appended figures, wherein:

FIG. 1 depicts a plan view of a graphical user interface for a user to select a region of interest, a maximum allowed computation time and other reconstruction options in accordance with an exemplary embodiment of the present disclosure; and

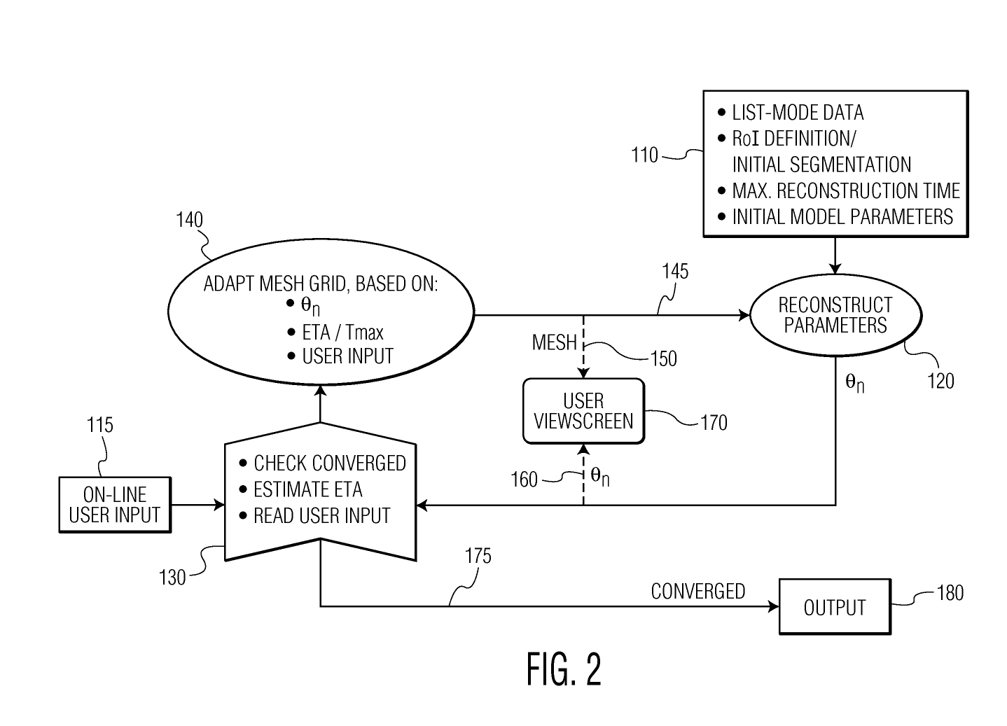

FIG. 2 is a flow chart illustrating a reconstruction process using the graphical user interface of FIG. 1 in accordance with an exemplary embodiment of the present disclosure.

As set forth herein, the present disclosure advantageously provides a direct, iterative reconstruction method that uses an adaptive mesh grid. The grid layout is determined by a priori indication of regions of interest and a state of the reconstruction process. Early iterations, where parameter estimates are still coarse, feature low resolution grids. The resolution is increased with each iteration, reaching its peak when parameter estimates start to converge. The grid layout is also determined by available data per voxel. In regions of little activity, voxels are merged (e.g., pooled) to form a coarse grid, with a better signal-to-noise ratio for each voxel. Spatial variation of the reconstructed parameters is also used to determine the grid layout. Areas of high variation are overlaid with a finer voxel grid. The grid layout is further determined by selection of a maximum computation time allowed. Before reconstruction starts, the user defines a maximum computation time. After each iteration the remaining computation time is estimated, and the grid resolution is adapted (e.g., made coarser or finer) depending on whether the allowed computation time will be exceeded or met (e.g., easily). Other user interaction is also used to determine the grid layout as discussed more fully below.

Referring to FIG. 1, user interaction, both a priori and on-line, proceeds through a graphical user interface (GUI) 10. Before the reconstruction starts, the user is prompted to indicate regions of interest in a previously made reconstruction, possibly obtained using a different modality, such as computer tomography (CT), for example. The user can indicate the regions of interest using a navigation window 12 generally indicated at the lower right of the graphical user interface 10, as illustrated in FIG. 1. Alternatively, a mouse and/or a keyboard with short cuts (not shown) could be used. The user also sets the maximum computation time allowed and further reconstruction options.

During the reconstruction process (e.g., on-line), the user sees the currently used (3-D) grid 14 and the reconstructed model parameter values that are intensity coded per voxel at 16 and define a reconstructed parameter map 15. The user views both on a display 17 that shows the current estimation of the reconstructed parameter map 15, along with the mesh grid 14 that is currently used. By navigating a 3-D cursor 19 through the grid 14 with arrow buttons 18 and resizing the grid 14 with sizing buttons 20 in which the user can select a region to increase or decrease the resolution. The entire image can also be rotated around three axes using a respective button 22. The buttons indicated generally at the left of the GUI 10 are present for global action indicated generally at 24, a log message window 26 indicates reconstruction progress and feedback relative to the user's actions. In addition, the log message window 26 provides information concerning the convergence of the estimated parameters, estimated time left, and current resolution, also based on the user's actions. The user can also choose to increase or decrease the overall resolution, as well as to increase or decrease the speed of the reconstruction parameter process using buttons 28 and 30, respectively.

Referring now to FIG. 2, the parameter reconstruction process will be described with reference to the flow chart indicated generally at 100. The user inputs list mode data, a region of interest definition/initial segmentation, a maximum reconstruction time period and initial mode parameters at block 110. These user inputs are forwarded to the reconstructor at block 120 for an initial iteration. After each iteration of the reconstructor, the reconstructed parameters at block 130 are checked for convergence, an estimate is made for the required computation time, and any on-line input from the user at block 115 is read at block 130. Next, the mesh grid is updated at block 140. The mesh grid is updated at block 140 based on the local variability of the reconstructed parameters (θₙ), the ratio of the computation time that is still required and the allowed computation time left (ETA/Tmax), and the commands from the user (User input). The next iteration of the reconstructor is based on the adapted mesh indicated with line 145 to block 120.

The user receives information about the current parameter estimates (θₙ), indicated with broken line 160, and mesh grid 14, indicated with broken line 150, via display 17 at block 170. The user may actively influence the mesh grid 14 at blocks 110 and 115 as discussed above. When the reconstruction is completed or the reconstruction cycle has converged, indicated with line 175, the reconstructed image is output at block 180. It will be recognized by one skilled in the pertinent art that although the display 17 is shown as part of the GUI 10, that the display 17 may be an independent display separate from the user input buttons located on the lower and left-hand sides of the display 17, as illustrated in FIG. 1

Each estimation of the required computation time depends on the current mesh grid and the expected number of iterations. The latter is easily calculated in the so-called one-pass algorithms, where all data is seen exactly once, or other algorithms with a fixed number of iterations. Algorithms that depend explicitly on the convergence of the reconstructed parameter estimates, need to estimate the number of iterations that are left based on convergence statistics.

Reconstruction algorithms are known in the art that yield an updated θₙ for the model parameters after each event, after a subset of the complete set of events or after an iteration that includes all events. To ensure proper user interaction, the number of events that is used per iteration (e.g., for each parameter update) must be chosen small enough to give the user the chance to interact at reasonable intervals.

It should be noted that user interaction may not only take place during the reconstruction, but also after the reconstruction has finished. When the reconstruction cycle has converged, the state of the system (e.g., the currently used voxel grid and the estimated model parameter values) are stored in the computer memory. The graphical user interface 10 still allows the user to increase the spatial resolution in areas of interest, based on the reconstructed image, whereafter the reconstruction cycle may continue. An example of the use of this feature would be to make an initial “quick reconstruction”, increase the resolution in, possibly patient specific, regions of interest, and then to allow the system to continue with the “main reconstruction”.

Advantageously, embodiments of the present disclosure enable a user of the system, method and computer software product to visually inspect an on-line representation of the reconstructed parameters and mesh grid during reconstruction. Further, the system, method and computer software product of the present disclosure facilitates on-line user interaction with the reconstruction process through manual adaptation of the local and global mesh grid resolution and uses the estimated remaining computation time as a determining factor in mesh adaptation.

Other advantages include a smaller dependence on a priori availability of reconstructed data. For example, a coarse first indication of regions of interest may be refined on-line, as soon as reconstructed data becomes available. The system, method and computer software product of the present disclosure also provides more control over the reconstruction process. For example, an automatic, data-driven mesh segmentation may differ from the choices of a human expert. Although the option to trust the reconstruction algorithm with the choice of which areas deserve high resolution still exists, the user interface adds the option to make human expert knowledge an active part of the decision process. Interesting features that arise unexpectedly in the reconstructed parameter map may be examined “more closely” (e.g., under a higher resolution) as soon as the features of interest start to show up in the reconstruction. Thus, there is no need to complete the entire reconstruction, add or change regions of interest, and re-run the reconstruction. Another advantage provided by the above described system, method and computer software product of the present disclosure includes the option to set a maximum computation time to prevent unnecessary waiting, and ensuring maximum resolution within the boundaries of the allowed time.

Although the method, system and software product of the present disclosure have been described with reference to exemplary embodiments thereof, the present disclosure is not limited to such exemplary embodiments. Rather, the method, system and software product disclosed herein are susceptible to a variety of modifications, enhancements and/or variations, without departing from the spirit or scope hereof. Accordingly, the present disclosure embodies and encompasses such modifications, enhancements and/or variations within the scope of the claims appended hereto.

1. A method for iterative reconstruction with user interaction in data-driven, adaptive mesh generation for reconstruction of model parameters from imaging data, the method comprising:
reading input (110,115) from a user;
checking reconstructed parameters (130) for convergence after each iteration;
estimating a required computation time (130) after each iteration based on a current mesh grid and expected number of iterations;
updating the mesh grid (140);
displaying an on-line representation of the reconstructed parameters and an adapted mesh grid during the reconstruction (170); and
basing a next iteration of the reconstruction on the adapted mesh grid (145).

2. The method of claim 1, wherein the updating the mesh grid is based on at least one of a local variability of the reconstructed parameters (θₙ), a ratio of computation time still required and an allowed computation time left, and the user input.

3. The method of claim 1, wherein the reading of user input (110,115) takes place at least one of during reconstruction and after the reconstruction is completed.

4. The method of claim 3, wherein the user input includes one of:
a region of interest;
a desired resolution of the region of interest;
a maximum computation time allowed to complete reconstruction; and
a change in the maximum computation time allowed.

5. The method of claim 1, further comprising storing in a storage means a currently used voxel grid and estimated model parameter values when the reconstruction parameters have converged.

6. The method of claim 1, further comprising:
forming an initial reconstructed image;
increasing the spatial resolution in a region of interest based on an initial reconstructed image; and
continuing a main reconstruction cycle.

7. The method of claim 1, further comprising using an estimated remaining computation time as a determining factor in mesh adaptation of the adapted mesh grid.

8. The method of claim 1, further comprising facilitating on-line user interaction with the reconstruction through manual adaptation of at least one of local and global mesh grid resolution.

9. The method of claim 1, wherein the reconstructed parameters are derived from data gathered from imaging modalities.

10. The method of claim 1, wherein the estimating a required computation time after each iteration estimates the remaining computation time based on an input of maximum computation time allowed from the user input and the mesh grid is adapted depending on whether completion of reconstruction is expected to be met within the maximum computation time allowed.

11. The method of claim 1, wherein the reading input from a user includes reading input that is input via a graphical user input.

12. A method for iterative reconstruction with user interaction in data-driven, adaptive mesh generation for reconstruction of model parameters from imaging data, the method comprising:
indicating regions of interest in a previously made reconstruction of the image data using a graphical user interface (110);
inputting a maximum computation time via the graphical user interface for a reconstructor to complete a reconstruction (110);
inputting initial mode parameters via the graphical user interface (110);
initiating an iteration (120);
checking the reconstructed parameters for convergence (130);
estimating required remaining computation time against the maximum computation time (130);
updating the mesh grid with any user input (115) to the graphical user interface and ratio of computation time required and computation time remaining (140);
displaying current parameter estimates at the graphical user interface (170); and
outputting the reconstruction when it is one of completed and the reconstruction parameters have converged (180).

13. A system for iterative reconstruction with user interaction in data-driven, adaptive mesh generation for reconstruction of model parameters from imaging data, the system comprising:
a reconstructor configured to check reconstructed parameters for convergence after each iteration and estimate a required computation time after each iteration based on a current mesh grid and expected number of iterations;
a user interface configured to accept user input for the reconstructor to read;
a display means 17 to display an on-line representation of the reconstructed parameters and an adapted mesh grid during the reconstruction updating the mesh grid 14; and
wherein a next iteration of the reconstruction is based on the adapted mesh grid.

14. The system of claim 13, wherein the user interface and the display means 17 is a graphical user interface 10.

15. The system of claim 13, wherein the updated mesh grid is based on at least one of a local variability of the reconstructed parameters (θₙ), a ratio of computation time still required and an allowed computation time left, and the user input.

16. The system of claim 13, wherein user input is read at least one of during reconstruction and after the reconstruction is completed.

17. The system of claim 16, wherein the user input includes one of:
a region of interest;
a desired resolution of the region of interest;
a maximum computation time allowed to complete reconstruction; and
a change in the maximum computation time allowed.

18. The system of claim 13, further comprising a storage means for storing a currently used voxel grid and estimated model parameter values when the reconstruction parameters have converged.

19. The system of claim 13, wherein the reconstructor estimates the required computation time after each iteration by estimating the remaining computation time based on an input of maximum computation time allowed from the user input and the mesh grid is adapted depending on whether completion of reconstruction is expected to be met within the maximum computation time allowed.

20. A computer software product for iterative reconstruction with user interaction in data-driven, adaptive mesh generation for reconstruction of model parameters from imaging data, the product comprising a computer-readable medium, in which program instructions are stored, which instructions, when read by a computer, cause the computer to:
read input (110, 115) from a user input device;
check reconstructed parameters (130) for convergence after each iteration;
estimate a required computation time (130) after each iteration based on a current mesh grid and expected number of iterations;
update the mesh grid (140);
display on a display means an on-line representation of the reconstructed parameters and an adapted mesh grid during the reconstruction (170); and
base a next iteration of the reconstruction on the adapted mesh grid (145).
